(19) United States
(12) Patent Application Publication
(10) Pub. No.: US 2010/0303470 A1
(43) Pub. Date: Dec. 2, 2010

(54) OPTICAL TRANSMITTER

(75) Inventor: Kenichi NAKAMOTO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Opitical Components Limited, Kawasaki (JP)

(21) Appl. No.: 12/785,560

(22) Filed: May 24, 2010

(30) Foreign Application Priority Data
May 29, 2009 (JP) 2009-131229

(51) Int. Cl. H04B 10/04

(52) U.S. Cl. 398/185

(57) ABSTRACT

An optical transmitter includes an optical modulator including a phase modulator, and a delay interferometer to delay and interfere a part of an optical output of the optical modulator, and a controller to control an amplitude of a driving DPSK modulation signal to be supplied to the optical modulator based on a result derived from a level of an output signal of the delay interferometer.

### CROSS-REFERENCE TO RELATED APPLICATION

This application is based upon and claims the benefit of priority of the prior Japanese Patent Application No. 2009-131229, filed on May 29, 2009, the entire contents of which are incorporated herein by reference.

### FIELD

The embodiments discussed herein relates to an optical transmitter.

### BACKGROUND

As increasing the speed of optical transmission, a phase modulation scheme such as DPSK is adopted as an optical modulation scheme. For example, Japanese Laid-open patent application 2008-249848 discloses a technique for controlling an amount of amplitude of an output signal of modulator driver to 2 Vπ using a low frequency sine signal.

### SUMMARY

According to an aspect of the invention, an optical transmitter comprises an optical modulator including a phase modulator and a delay interferometer to delay and interfere a part of an optical output of the optical modulator, and a controller to control an amplitude of a driving DPSK modulation signal to be supplied to the optical modulator based on a result derived from a level of an output signal of the delay interferometer.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of an optical transmitter according to a first embodiment;

FIG. 2A explains a waveform of an ideal driving signal and FIG. 2B for explaining a waveform of an actual driving signal;

FIGS. 3A to 3D explain a relationship between an amplitude of the driving signal and a tolerance of an optical signal to noise ratio;

FIG. 4 illustrates a configuration of an optical transmitter according to a second embodiment; and

FIG. 5 illustrates a configuration of an optical transmitter according to a third embodiment.

### DESCRIPTION OF EMBODIMENTS

The technique disclosed in Japanese Laid-open patent application 2008-249848 needs that a superimposed pilot signal is synchronously detected at controlling the amplitude of output signal of the modulator driver. However, a circuit practicing this function may result in a large size. Accordingly, an optical transmitter is desired to control appropriately the amplitude of output signal of the modulator driver with a little increase of circuit size or without increase of the circuit size.

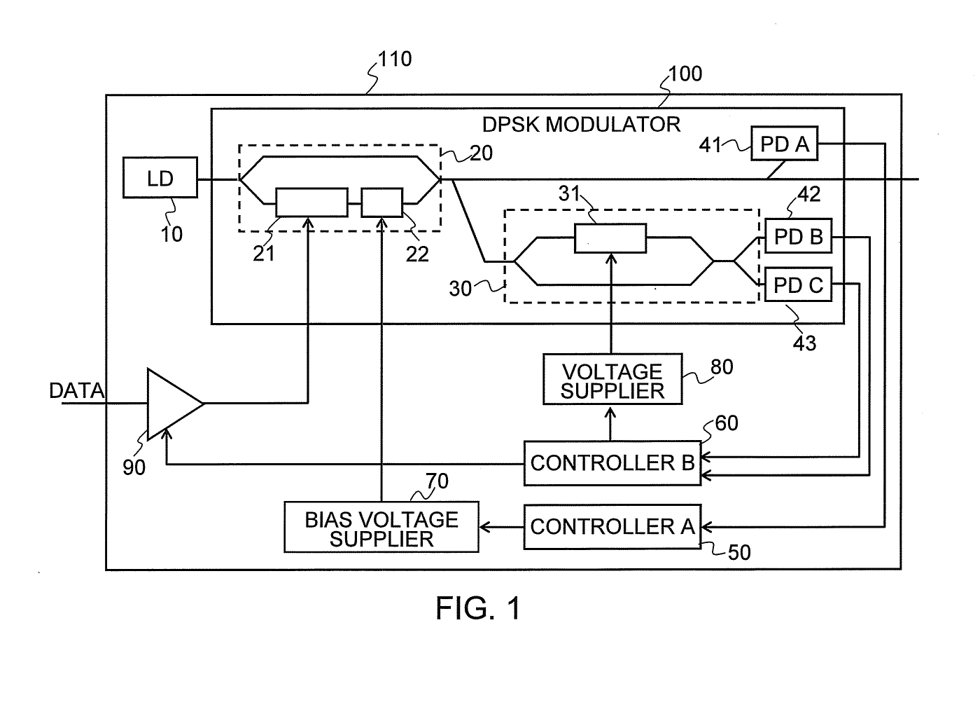

A first embodiment according to the present invention will be explained with reference to FIGS. 1 to 3. FIG. 1 is a block diagram illustrating a configuration of an optical transmitter 110 as a first embodiment. The optical transmitter 110 includes a light source 10, a phase modulator 20, a delayed interferometer 30, an optical receiver A 41, an optical receiver B 42, an optical receiver C 43, a controller A 50, a controller B 60, a bias voltage supplier 70, a delayed interferometer source voltage supplier 80, and an driver 90.

The light source 10 generates a light to be sent to the phase modulator 20. The phase modulator 20 modulates the light by a driving DPSK modulation signal V_{drv} outputted from the driver 90, where DPSK is a differential phase shift keying. In more detail, the phase modulator 20 is made of a substrate, such as LiNbO₃, having electro-optical property and has two optical waveguides between an input and an output. To one of optical waveguide, phase modulating elements 21 and 22 are provided. The light passing through the phase modulating element 21 undergoes phase modulation at a degree corresponding the driving DPSK modulation signal V_{drv}. Then the modulated light undergoes phase modulation, by the phase modulating element 22, at a degree corresponding the bias voltage supplied by the bias supplier 70 to the phase modulating element 22. The lights passing through the two optical waveguides in the phase modulator 20 interfere with each other and the interfered light is outputted from the phase modulator 20.

Receiving a data signal DATA, the driver 90 processes the signal to a driving DPSK modulation signal V_{drv} which is sent to the phase modulating element 21 arranged in the phase modulator 20. The voltage amplitude of the driving DPSK modulation signal V_{drv} is varied by the controller B 60.

The signal light output from the phase modulator 20 is separated by a splitter or the like, which is not illustrated in FIG. 1, into two split lights. Optically receiving the one of the split lights, the optical receiver A 41 converts the received light into an electronic signal, where the optical receiver A 41 includes an element for converting a light to electric energy such as a photo diode. Further, the optical receiver A 41 amplifies the electronic signal to feed the amplified electronic signal to the controller A 50. The controller A 50 controls the bias voltage supplier 70 so as to supply a bias voltage to the phase modulating element 22.

The other of the split lights is input to the delayed interferometer 30 which is configured to include two optical waveguides. One of the optical waveguides is provided with a delay amount controller 31. During flowing or conducting through the delay amount controller 31, an amount of delay of the light is varied in response to the voltage applied by the delay-interferometer voltage supplier 80 to the delay amount controller 31. According to a requirement from the controller B 60, the delay-interferometer voltage supplier 80 controls the delay amount controller 31 so that the amount of delay results in a difference by one bit, for example, between the lights travelling respective optical waveguides. The two lights traveling the respective optical waveguides interfere with each other and output from the delay interferometer 30.

The delay interferometer 30 outputs an optical signal of a normal in phase and an optical signal of a reverse in phase. The optical signals of a normal in phase and of a reverse in phase are optically received by the optical receiver B 42 and by the optical receiver C 43 respectively. Receiving the optical signals, the optical receivers 42 and 43, which include individually optical detector such as a photo diode, transforms the optical signals to relative electrical signals. The more the intensities of the light received by the optical receivers 42 and 43, the more the individual current intensities of the electrical signals transformed by the corresponding optical receivers 42 and 43 may become. The optical receivers 42 and 43 amplify the corresponding electrical signals to be fed to the controller B 60. The controller B 60 controls the amplitude of the driving DPSK modulation signals V_{drv} on the basis of the electrical signals received from the optical receivers 42 and 43.

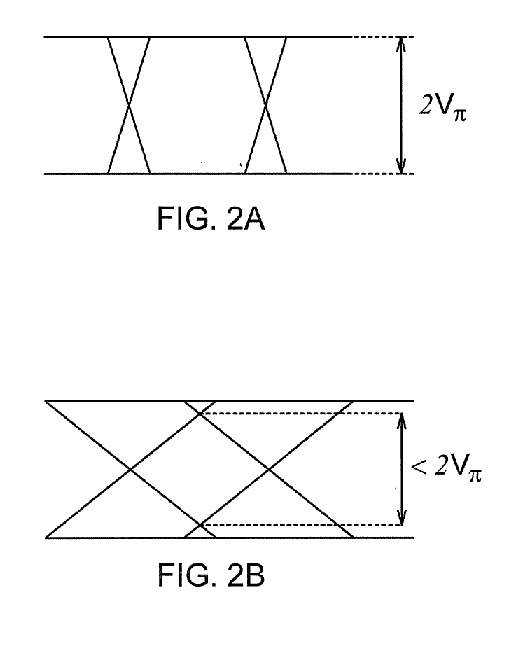

Increasing the transmission rate in optical transmission, an actual amplitude of the driving DPSK modulation signal V_{drv} occasionally becomes smaller than 2 V_{π}, where V_{π}generates a phase difference π between signals flowing two optical waveguides in a phase modulator when the V_{π}is applied to the phase modulator. FIG. 2A is a diagram for explaining the ideal amplitude of the driving DPSK modulation signal 2 V_{π}and FIG. 2B for the actual driving DPSK modulation signal 2V_{π}. In the case of the relative low transmission rate in the optical transmission, the amplitude of the driving DPSK modulation signal V_{drv} is maintained as illustrated in FIG. 2A.

However, in the case of a high transmission rate in the optical transmission, the amplitude of the driving DPSK modulation signal V_{drv} may become smaller than decrease 2V_{π}, which may be caused by deteriorations of a pulse rise time Tr, a pulse fall time Tf of the driving DPSK modulation signal, or a LN band and the like. The decrease in the amplitude of the driving DPSK modulation signal V_{drv} may cause a bit error rate (BER) to be worse which leads to lower tolerance of an optical signal to noise ratio (OSNR).

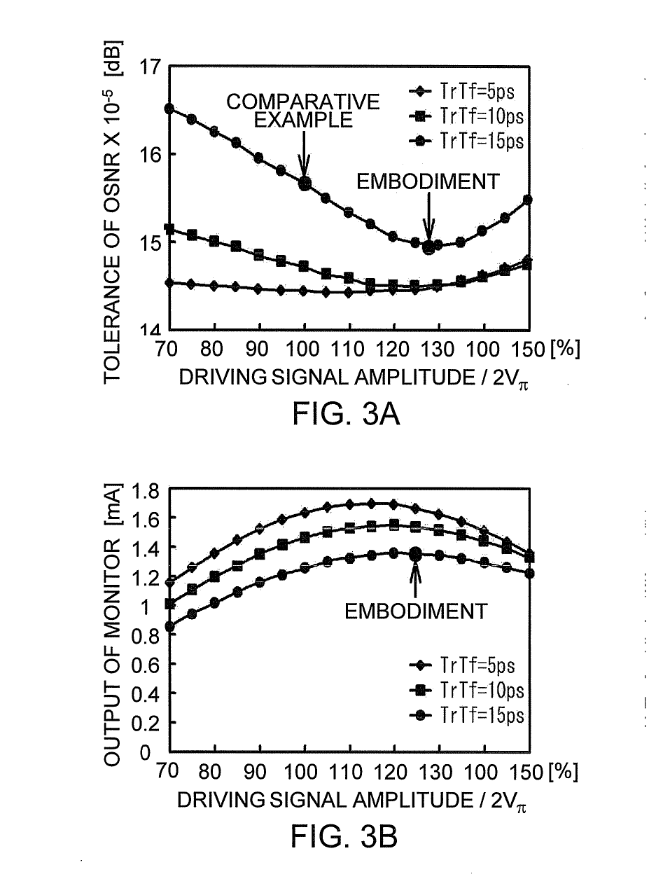

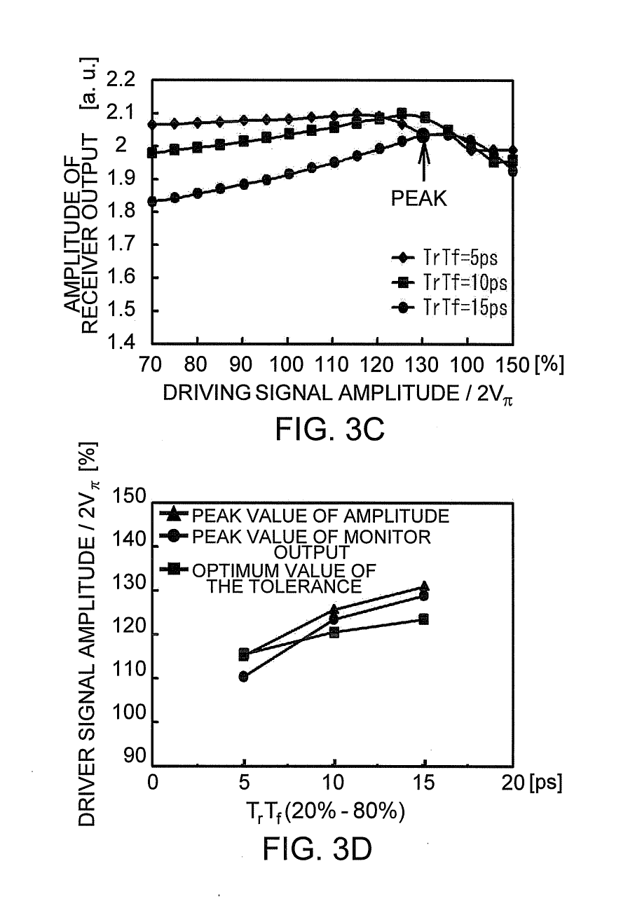

It was investigated how the amplitude of the driving DPSK modulation signal effects on OSNR. The results are depicted in FIG. 3A which illustrates the relationship between the ratio of the amplitude of the driving DPSK modulation signal to V_{drv} plotted along the abscissa and the tolerance of OSNR plotted along the ordinate. FIG. 3A illustrates the three results in the cases that the TrTf(20%-80%) is 5 ps, 10 ps, and 15 ps respectively. The comparative examples are each of the tolerance of OSNR corresponding to the 2 V_{π} of the amplitude of the driving DPSK modulation signal V_{drv}.

As illustrated in FIG. 3A, the longer the TrTf(20%-80%) becomes, the larger fluctuation appears in each tolerance of OSNR, resulting in that each tolerance of OSNR at larger than 2V_{π} is improved better than that at 2V_{π} of the amplitude of the driving DPSK modulation signal V_{drv}. For example in the case of 15 ps of TrTf(20%-80%), the best tolerance of OSNR is obtained at the approximate 1.3 times than 2V_{π} of the amplitude of the driving DPSK modulation signal V_{drv}. Thus, the improvement of the tolerance of OSNR is made by an amplitude of the driving DPSK modulation signal V_{drv} larger than 2V_{π}.

FIG. 3B explains the relationship between the amplitude of the driving DPSK modulation signal 2V_{π} and the sum of output values, that is sum of the output values of the optical signals of a normal in phase and of a reverse in phase, of the optical receivers 42 and 43. In FIG. 3B, the ration of the amplitude of the driving DPSK modulation signal to V_{drv} is plotted along the abscissa and the sum is plotted along the ordinate. As illustrated in FIGS. 3A and 3B, the best tolerance of OSNR and the peak of the sum are given at approximately same amplitude of V_{drv}. Therefore, detecting the sum of the outputs of the optical receivers 42 and 43 may predicate a value of the driving DPSK modulation signal V_{drv} which may give the most improved tolerance of OSNR. For example, controlling the amplitude of the driving DPSK modulation signal V_{drv} so as to give the sum of the outputs of the optical receivers 42 and 43, the most improved tolerance of OSNR may be obtained.

Further, it is preferable to control the voltage supplied to the delay amount controller 31 by the controller B 60 so that the difference between the outputs of the optical receivers 42 and 43 reaches to its peak value. In this case, the peak value will be more accurately detected.

FIG. 3C is a diagram for explaining the relationship between the amplitudes of the driving DPSK modulation signal V_{drv} and the receiver output, where the ratios of the amplitudes of the driving DPSK modulation signal V_{drv} to the value 2V_{π} are plotted along the abscissa and the amplitudes of receiver output are plotted along the ordinate. As illustrated in FIG. 3C, the peak of each receiver output and the most improved tolerances of the OSNRs in FIG. 3A are given at the same value of the amplitude of the driving DPSK modulation signal V_{drv}.

FIG. 3D is a diagram for explaining the relationship between TrTf and the amplitude of the driving DPSK modulation signal V_{drv}/2V_{π}, where values of TrTf(20%-80%) are plotted along the abscissa and the amplitudes of the receiver output are plotted along the ordinate. As illustrated in FIG. 3D, the optimum values of the OSNR and the peak values of the monitor output, which is sum of the outputs of the optical receivers 42 and 43, are approximately same at 5, 10, and 15 ps of TrTf(20%-80%).

In this embodiment, the tolerance of the OSNR may be improved based on the output of the delayed interferometer. Therefore, the amplitude of the driver may be approximately controlled. The optical transmitter 110 may be simply configured to lead to a smaller size of a circuit implemented therein.

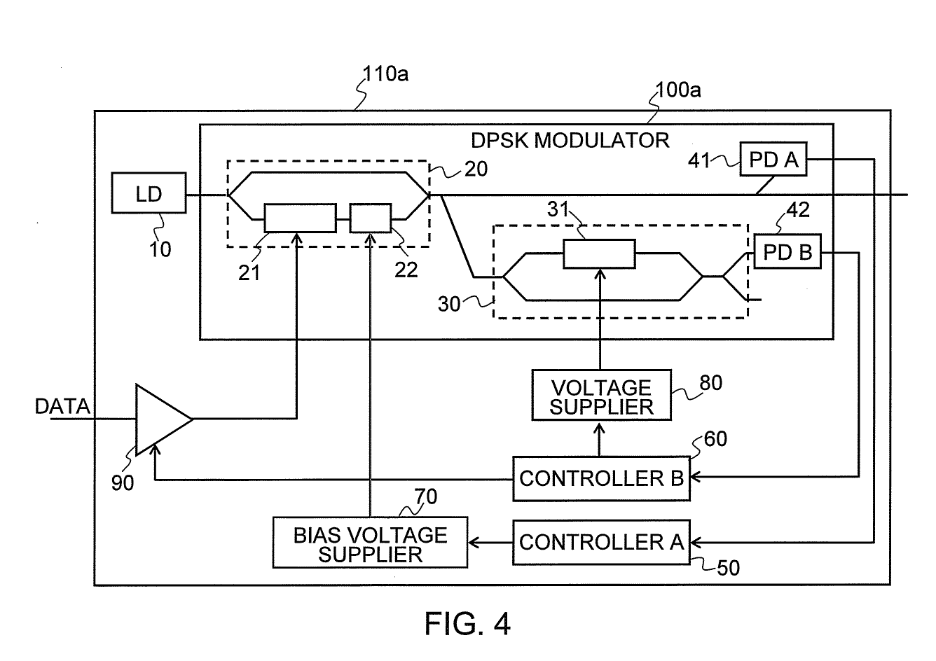

The second embodiment will be explained hereinafter. FIG. 4 illustrates the configuration of the optical transmitter 110a according to the second embodiment. The optical transmitter 110a differs from the optical transmitter 110 in that the optical transmitter 110a does not include the optical receiver C 43. In optical transmitter 110a, the peak, that is the peak of the optical intensity of a normal phase, of the output from the optical receiver B 42 may be obtained instead of obtaining the peak of the sum of outputs from the optical receivers 42 and 43 in the first embodiment. Since the peaks of the output from the optical receiver B 42 and the sum of outputs from the optical receivers 42 and 43 are close to each other, it may be preferable to control the amplitude of the driving DPSK modulation signal V_{drv} so as to obtain the maximum output of the optical receiver B 42, which may lead to improve the tolerance of OSNR.

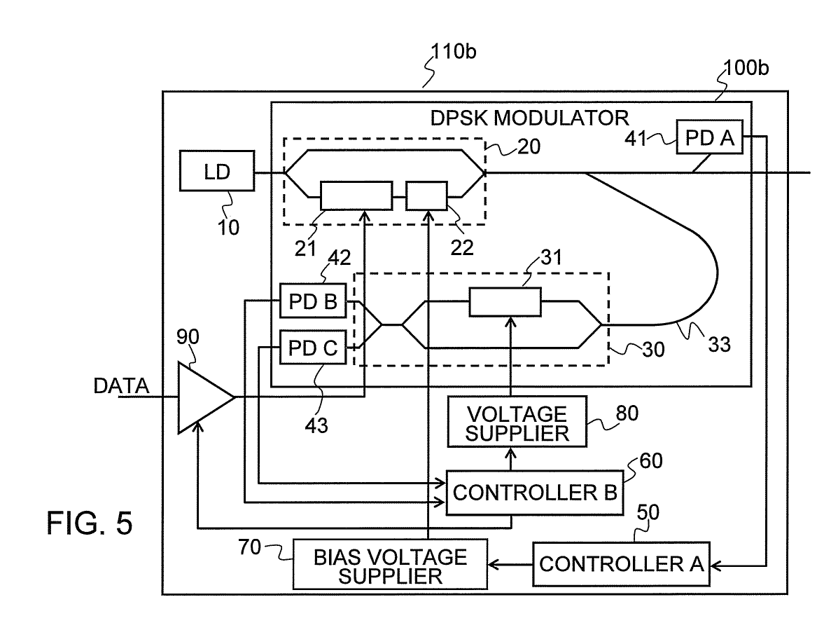

Referring to FIG. 5, the third embodiment will be explained hereinafter. FIG. 5 is a diagram for explaining the configuration of an optical transmitter 110b according to the third embodiment. The optical transmitter 110b differs from the optical transmitter difference 110 in that the optical transmitter 110b additionally includes a folded bend waveguide 33 as illustrated in FIG. 5. The phase modulator 20 and the delay interferometer 30 are optically connected with the folded bend waveguide 33 to prevent the optical transmitter 110b from increasing the longitudinal size thereof. Further using the folded bend waveguide 33 serves to decrease an optical loss.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An optical transmitter comprising:
an optical modulator including a phase modulator and a delay interferometer to delay and interfere a part of an optical output of the optical modulator; and
a controller to control an amplitude of a driving DPSK modulation signal to be supplied to the optical modulator based on a result derived from a level of an output signal of the delay interferometer.

2. The optical transmitter according to claim 1, wherein the controller controls the amplitude of the driving DPSK modulation signal based on a sum of an intensity of an optical signal of a normal in phase and an intensity of an optical signal of a reverse in phase from the delay interferometer.

3. The optical transmitter according to claim 1, wherein the controller controls the amplitude of the driving DPSK modulation signal so that a sum of an intensity of an optical signal of a normal in phase and an intensity of an optical signal of a reverse in phase from the delay interferometer reaches to a peak value.

4. The optical transmitter according to claim 1, wherein the controller controls the amplitude of the driving DPSK modulation signal so that an intensity of an optical signal of a normal in phase from the delay interferometer reaches to a peak value.

5. The optical transmitter according to claim 1, wherein the controller controls a voltage to be supplied to the the delay interferometer so that a difference between an intensity of an optical signal of a normal in phase and an intensity of an optical signal of a reverse in phase from the delay interferometer reaches to a peak value.

6. The optical transmitter according to claim 1, wherein the controller controls a voltage to be supplied to the the delay interferometer so that an intensity of an optical signal of a normal in phase from the delay interferometer reaches to a peak value.

7. The optical transmitter according to claim 1, wherein the phase modulator is a waveguide modulator.

8. The optical transmitter according to claim 1, wherein the phase modulator and the delay interferometer are connected with a bend waveguide each other.
